(19) United States
(12) Patent Application Publication
(10) Pub. No.: US 2017/0288560 A1
(43) Pub. Date: Oct. 5, 2017

(54) ARRANGEMENT FOR CONNECTING A RAILWAY POWER SUPPLY FOR A RAILWAY TRACK TO A THREE-PHASE SUPPLY NETWORK

(71) Applicant: SIEMENS AKTIENGESELLSCHAFT, MUENCHEN (DE)

(72) Inventors: WOLFGANG BRAUN, VIERETH-TRUNSTADT (DE); RAINER GRUBER, HEILSBRONN (DE)

(21) Appl. No.: 15/507,266

(22) PCT Filed: Jul. 14, 2015
(86) PCT No.: PCT/EP2015/068733

§ 371 Date: Feb. 28, 2017

(30) Foreign Application Priority Data
Aug. 29, 2014 (DE) 10 2014 217 300.0

(51) Int. Cl. H02M 5/14; H02J 3/26

(52) U.S. Cl. CPC H02M 5/14; H02J 3/26; H02M 2007/4835

(57) ABSTRACT

An arrangement for connecting a railway power supply for a railway track to a three-phase supply network. The arrangement has a three-phase AC transformer and a balancing device for a uniform electric load of the three phases of the three-phase supply network. The three-phase AC transformer is configured for connecting to the three-phase supply network on the primary side and is connected to the balancing device on the secondary side. The three-phase AC transformer is configured for connecting to a railway power supply which has an autotransformer system with two contact lines and two conductors that are carried along the railway track in an insulated manner.

The invention relates to an arrangement for connecting a railroad power supply for a railroad track to a three-phase supply network according to the precharacterizing clause of claim 1.

Single-phase catenary systems for which electrical energy must be taken from traditional three-phase supply networks are frequently used for a railroad power supply.

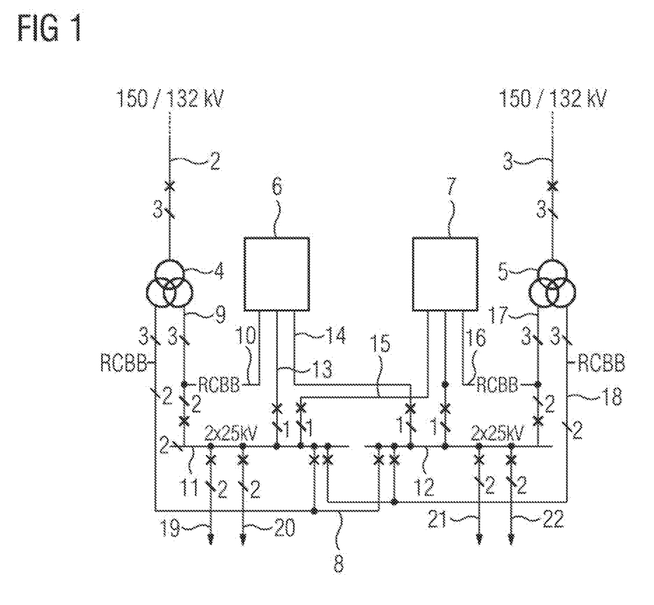

Various connection options of the railroad power supply to a three-phase supply network are known from pages 76 to 85 of the reference book “Fahrleitungen elektrischer Bahnen” [Contact lines of electric railroads] by F. Kieβling, R. Puschmann and A. Schmieder, 3rd edition, 2014. Thus, with a so-called single-phase railroad in each case the necessary voltage can be taken by turns for individual sections of the railroad power supply from individual external conductors of a three-phase supply network (FIG. 1.29 on page 77). This causes asymmetries in the load of the three-phase supply network. Furthermore, a so-called dual-voltage railroad power supply (FIG. 1.30 on page 78, text page 78 ff) is described in which autotransformers are used.

In the known autotransformer system, in a substation of the railroad power supply, a contact line, the so-called “positive feeder”, and a conductor that is carried along the railroad track in an insulated manner, the so-called “negative feeder”, are supplied by means of transformers from a three-phase supply network for each contact line section. The rail, which has ground potential, is connected to the substation. Along the contact line section there is at least one autotransformer which is connected to the two conductors and at its center tap to the rail. If the contact line section is traversed by a traction unit, the traction unit takes a first supply current from the direction of the substation and a second supply current from the direction of the end of the contact line section. Both the supply currents are phase-shifted by 180°.

Autotransformer systems are used for railroad power supply because the load currents of the contact line are halved over long distances and thereby the corresponding voltage drops are also reduced. The distances from substations to the railroad track can therefore be increased for autotransformer systems in the railroad power supply, reducing cost. Moreover, interference on communication lines is reduced.

Furthermore, a generic arrangement is known from DE102008012325 A1. The arrangement serves to connect at least one single-phase supply line for the overhead line of a railroad track to a three-phase supply network, wherein on the primary side at least one transformer is connected to the supply network and on the secondary side to the at least one single-phase supply line and to a grounding point or to a return line. In this instance, the transformer has three phases in each case both on the primary side and on the secondary side. A balancing device is connected to the at least one single-phase supply line and to the grounding point, reducing a so-called unbalanced load or an asymmetrical electric load of the three phases of the supply network. The balancing device is embodied as a three-phase self-commutated voltage-controlled converter.

Moreover, it is possible to connect two transformers to the three-phase supply network in order to supply two different overhead line sections by means of the balancing device. In this instance, the two transformers have two phases both on the primary side and on the secondary side.

Furthermore, a balancing device is known from the product description “SVC PLUS—System Description” from Siemens AG of Mar. 8, 2012. A so-called modular multilevel converter is used for reactive power compensation.

Based on DE102008012325 A1, the object of the invention is to specify an arrangement for connecting a railroad power supply for a railroad track to a three-phase supply network with which two contact line sections of an autotransformer system are supplied with electric energy comparatively simply and efficiently and at the same time asymmetries of the electric load of the three-phase supply network are avoided.

The invention achieves this object by means of an arrangement according to claim 1.

Although in its precharacterizing clause DE102008012325 A1 states that the single-phase supply line of the railroad power supply described in this document can be part of an autotransformer system, the manner in which the three-phase AC transformer should be employed for this purpose remains open.

It is an advantage of the arrangement according to the invention that with it two different contact line sections can be supplied in a simple and efficient interconnection of the three-phase AC transformer and the balancing device, at the same time avoiding asymmetries in the electric load of the three-phase supply network.

A further advantage is that the use of the balancing device on the secondary side of the three-phase AC transformer, in other words at the medium voltage level, is particularly cost-effective compared with the use of a balancing device at the high voltage level or in the three-phase supply network.

In a preferred embodiment of the arrangement according to the invention, the three-phase AC transformer is a three-winding transformer. This is an advantage because a three-winding transformer has a comparatively simple construction and is widespread.

In a further preferred embodiment of the arrangement according to the invention the three-phase AC transformer has a star connection on the primary side. This is an advantage because this design is particularly simple and space-saving.

In a further preferred embodiment of the arrangement according to the invention, the three-phase AC transformer has a first delta connection on the secondary side which initiates a phase shift of the voltage of 150° with respect to the primary side.

In a further preferred embodiment of the arrangement according to the invention, the three-phase AC transformer has a second delta connection on the secondary side which initiates a phase shift of the voltage of 330° with respect to the primary side. This is an advantage because in this way a phase shift of 180° is produced between the overhead line and the negative feeder.

In a further preferred embodiment of the arrangement according to the invention, the connection point of the first and second delta connection is connected to the ground potential and to the balancing device. This is advantageous because in this way two equivalent voltages can be produced with respect to the ground potential (e.g. 2×25 kV) for the power supply of the railroad track so that the two voltages together have double the voltage difference (e.g. 50 kV).

In a further preferred embodiment of the arrangement according to the invention, the three-phase AC transformer with its first delta connection is connected to the balancing device and is suitable for supplying the two conductors that are carried along the railroad track in an insulated manner. The balancing device is designed to reduce the asymmetry in the electric load of the primary side of the three-phase AC transformer, for example by way of a reactive power compensation. This is an advantage as the first delta connection which supplies the negative feeder has a lower electric load than the second delta connection.

In a further preferred embodiment of the arrangement according to the invention, the three-phase AC transformer with its second delta connection is suitable for supplying the two contact lines. This is an advantage as the second delta connection which supplies the contact lines has a greater electric load than the first delta connection.

In a further preferred embodiment of the arrangement according to the invention, the three-phase AC transformer comprises the vector group YNd5dll according to the standard DIN VDE 0532. This is an advantage because this vector group is particularly suitable for supplying two negative and positive feeders each.

In a further preferred embodiment of the arrangement according to the invention, an additional three-phase AC transformer and an additional balancing device are interconnected such that the arrangement is suitable for supplying two electrically separate contact line sections, each with two contact lines, with energy.

In a development of the aforementioned embodiment, the two electrically separate contact line sections are supplied with energy by the additional three-phase AC transformer and/or the additional balancing device if a three-phase AC transformer and/or a balancing device fail. This is an advantage because when using two three-phase AC transformers and two balancing devices, the supply of the two contact line sections is also possible if a three-phase AC transformer and/or a balancing device fail.

In a further preferred embodiment of the arrangement according to the invention, the balancing device has a three-phase self-commutated voltage-controlled converter. This is an advantage because a three-phase self-commutated voltage-controlled converter enables a comparatively space-saving design.

In a further preferred embodiment of the arrangement according to the invention, the balancing device has a modular multilevel converter. This is an advantage because a modular multilevel converter enables comparatively high converter performance with comparatively high voltage quality.

To better explain the invention, the figures show

FIG. 1 a schematic diagram of a first exemplary embodiment of the arrangement according to the invention and

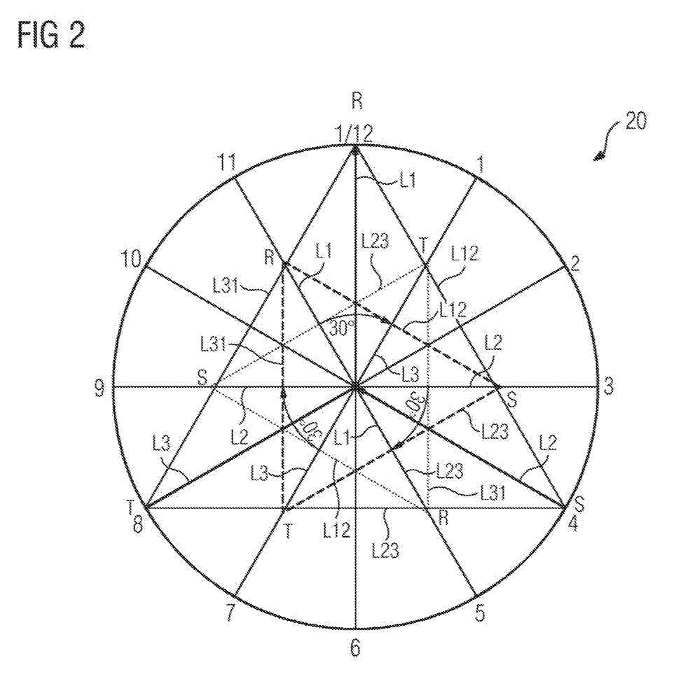

FIG. 2 a phasor diagram which shows the phase relationships between the primary side and the secondary side of a three-phase AC transformer used in the first exemplary embodiment and

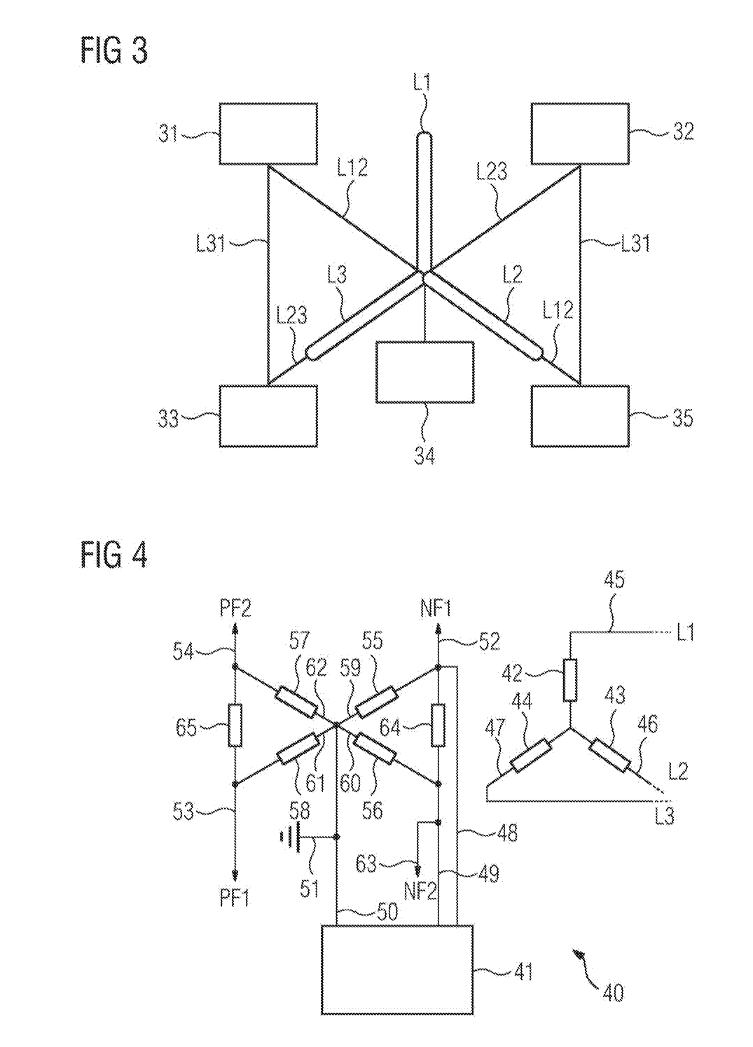

FIG. 3 a schematic diagram of a second exemplary embodiment of the arrangement according to the invention and

FIG. 4 a circuit diagram of a three-phase AC transformer according to the second exemplary embodiment.

FIG. 1 shows an arrangement 1 in which a three-phase supply network 2, 3 with e.g. 150 kV or 132 kV is connected to the primary side of two three-phase AC transformers 4, 5 respectively. The diagram is a simplified so-called single line diagram, i.e. a three-phase line is shown as a single line which is characterized by a line with a cross through it and a 3. Correspondingly, a two-phase connection is characterized by a 2. Moreover, there are two balancing devices 6, 7 and a ground or rail potential RCBB. The arrangement has two busbars 11, 12, wherein two contact lines (OCL) 19, 20, 21, 22 are connected to each busbar 11, 12.

The interconnection of the aforementioned elements will now be explained hereinafter. On the secondary side of the transformer 4 shown on the left, a first three-phase line 8 exits in which one phase is connected to the ground potential RCBB and the remaining two phases are supplied to the busbars 11, 12. A second three-phase line 9 is connected to the ground potential and via the remaining two phases to the busbars 11, 12. The balancing device 6, which is connected to the busbar 11 by way of a line 13, is connected to the ground potential by way of a line 10. The first balancing device 6 is connected to the busbar 12 by the line 14.

A second phase is supplied to the busbar 11 by the second balancing device 7 by way of the line 15. A further phase is also supplied to the busbar 12 by the balancing device 7. The third phase of the balancing device 7 is connected to the ground potential RCBB via the line 16. On the secondary side of the transformer 5 a three-phase line 17 exits from which one phase is connected to the ground potential RCBB and the remaining two phases are fed to the busbar 12. Moreover, from the transformer 5 a second three-phase line 18 exits from which one phase is supplied to the ground potential RCBB and the remaining two phases supply the busbars 11, 12.

An advantage of the arrangement shown is that the feeding of the railroad power supply can still be maintained if one of the two balancing devices 6, 7 and/or one of the two transformers 4, 5 fails. The two balancing devices are connected in parallel in the embodiment shown.

FIG. 2 shows a phasor diagram which represents the phase relationships between the radially configured primary side of a three-phase AC transformer designed as a three-winding transformer and two delta connections arranged on the secondary side. The outer circle shows angular displacements of 30° in each instance so that, for example, the number 3 stands for 3×30 =90° angular displacement. R, S, T stand for the three phases of the three-phase supply line L1, L2, L3. The star-shaped connection of L1, L2, L3 can be seen inside the circle.

A first delta connection (represented by broken lines) on the secondary side consists of the three windings L31, L23, L12. A second delta connection (represented by dotted lines) consists of the three windings L23, L12, L31. The two triangles are displaced relative to each other such that in each case the angle between R of the first delta connection and T of the second delta connection is 30°, i.e. there is an angular displacement of 180° between both delta connections. A connection of the two points of the first and second delta connection characterized by S produces a circuit diagram like that in the subsequent FIG. 3.

The circuit diagram 3 according to FIG. 3 shows the three windings L1, L2, L3 of the primary side of the three-phase AC transformer. The three windings L1, L2, L3 are radially configured, wherein the point of contact is connected to a return line and a balancing device (reference character 34).

On the right of the circuit diagram there is a first delta connection consisting of the three windings L12, L23, L31. The point of contact of the windings L12 and L31 is connected to a second negative feeder NF2 and to the balancing device (reference character 35). The point of contact of the two windings L23 and L31 is connected to a first negative feeder NF1 and to the balancing device (reference character 32).

On the left of the circuit diagram there is a second delta connection consisting of the three windings L12, L31, and L23. A first contact line 31 is connected at the point of contact of the two windings L12 and L31. A second contact line 33 is connected at the point of contact of the two windings L31 and L23.

The vector group of the three-phase AC transformer shown is YNd5dll.

FIG. 4 shows an arrangement 40, consisting of a balancing device 41 and a three-phase AC transformer. The three-phase AC transformer according to DIN VDE 0532 comprises the vector group YNd5dll. On its primary side three windings 42, 43, 44 are radially configured and connected to the three phases L1, L2, L3 of a three-phase supply network. On the secondary side, there is a first delta connection consisting of the windings 55, 56 and 64. The point of contact of the two windings 56 and 64 is connected to the balancing device 41 by way of a line 49. The same connection point is furthermore connected to a second negative feeder NF2 by way of the line 63. The connection point between the winding 55 and the winding 64 is connected by way of a line 52 to a first negative feeder NF1 and by way of a line 48 to the balancing device 41. The point of contact of the two windings 55 and 56 is brought out by means of the line 50 and on the one hand is connected by way of a line 51 to the ground or rail potential and on the other hand to the balancing device 41.

Moreover, on the secondary side there is a second delta connection consisting of the three windings 57, 58, 65. The point of contact of the two windings 57 and 58 is connected to the line 50 and to the point of contact of the two windings 55 and 56 of the first delta connection. A second positive feeder PF2 is connected at the point of contact of the windings 57 and 65 by way of a line 54. A first positive feeder PF1 is connected at the point of contact of the windings 58 and 65 by way of the line 53.

By means of the vector group YNd5dll shown of the three-phase AC transformer and its connection to the negative feeders NF1, NF2 and the balancing device it is possible to avoid asymmetries in the electric load of the windings 42, 43, 44 on the primary side of the transformer in a particularly efficient manner.

1-13. (canceled)

14. An arrangement for connecting a railroad power supply for a railroad track to a three-phase supply network, the arrangement comprising:
a balancing device for a uniform electric load of three phases of the three-phase supply network;
a three-phase AC transformer having a primary side to be connected to the three-phase supply network and a secondary side connected to said balancing device;
said three-phase AC transformer being configured for connection to a railroad power supply which has an autotransformer system with two contact lines and two conductors that are carried along the railroad track in an insulated manner.

15. The arrangement according to claim 14, wherein said three-phase AC transformer is a three-winding transformer.

16. The arrangement according to claim 14, wherein said three-phase AC transformer has a star connection on said primary side.

17. The arrangement according to claim 15, wherein said three-phase AC transformer has a first delta connection on said secondary side which causes a phase shift of a voltage of 150° with respect to said primary side.

18. The arrangement according to claim 17, wherein said three-phase AC transformer on said secondary side has a second delta connection which causes a phase shift of a voltage of 330° with respect to said primary side.

19. The arrangement according to claim 18, wherein a connection point of said first delta connection and said second delta connection is connected to ground potential and to said balancing device.

20. The arrangement according to claim 17, wherein said first delta connection of said three-phase AC transformer is connected to the balancing device and is configured for supplying said two conductors that are carried along the railroad track in an insulated manner.

21. The arrangement according to claim 18, wherein said second delta connection of said three-phase AC transformer is configured for supplying said two contact lines.

22. The arrangement according to claim 14, wherein said three-phase AC transformer comprises a vector group YNd5dll according to standard DIN VDE 0532.

23. The arrangement according to claim 14, which further comprises at least one of an additional three-phase AC transformer or an additional balancing device connected to enable the arrangement to supply energy to two electrically separate contact line sections, each having two contact lines.

24. The arrangement according to claim 23, wherein said additional three-phase AC transformer and/or said additional balancing device is configured to supply the two electrically separate contact line sections with energy if a three-phase AC transformer and/or a balancing device fails.

25. The arrangement according to claim 14, wherein said balancing device has a three-phase self-commutated voltage-controlled converter.

26. The arrangement according to claim 14, wherein said balancing device has a modular multilevel converter.
